(19) United States
(12) Patent Application Publication
(10) Pub. No.: US 2015/0140190 A1
(43) Pub. Date: May 21, 2015

(54) CONCENTRIC SYMMETRICAL BRANCHED HEAT EXCHANGER SYSTEM

(71) Applicant: Nestec SA, Vevey (CH)

(72) Inventors: Kevin J. Cully, Chesterfield, MO (US); Michael G. Rayner, St. Joseph, MO (US); Andrew Joseph Brinkmann, Manchester, MO (US)

(21) Appl. No.: 14/546,369

(22) Filed: Nov. 18, 2014

Related U.S. Application Data
(60) Provisional application No. 61/905,929, filed on Nov. 19, 2013.

(51) Int. Cl. A23P 1/10; A23L 1/317

(52) U.S. Cl. CPC A23P 1/10; A23L 1/317; A23V 2002/00
USPC 426/512; 426/518; 99/353

(57) ABSTRACT

A concentric symmetrical branched heat exchanger system includes an inlet manifold that divides the product flow evenly in the first section of the system and also includes an array of tubular concentric heat exchangers arranged in parallel and in series. Flow through each leg of the system can be divided further with secondary manifolds. Division of the product flow enables efficient heat exchange at higher and controllable product flow rates and at lower heat exchanger inlet pressures. Having lower inlet pressures reduces the heat exchanger construction cost and allows attachment of cutting or shaping devices at the exchanger exits to create uniquely shaped pieces. The cutting or shaping devices can be installed at the end of the branched heat exchanger to provide cooling and cutting in one process step while eliminating the material handling step of conveying product to and from a blast freezer or similar cooling device.

### BACKGROUND

The present disclosure generally relates to food processing systems and methods. More specifically, the present disclosure relates to a branched heat exchanger system through which food product can be pumped.

Heating or cooling of very viscous products is achieved using a concentric heat exchanger. In a concentric heat exchanger, product flows through an annulus formed between two overlapping tubes. By reducing the size of the annulus (gap between tubes), the product can be heated or cooled more effectively. However, reducing the size of the gap increases overall heat exchanger operating pressures. Higher operating pressures require a more robust heat exchanger design leading to higher equipment and lower flow rates. Reduced product gaps can also limit the range of products that can be processed including products consisting of particulates.

Cooling or heating protein-based emulsions is an extremely difficult heat transfer application. The difficulty is primarily due to the high viscosity, fibrous nature of the material, higher pressures and the need to maintain the underlying structure of the product as the product passes through the heat exchanger. For example, existing continuous in-line heat exchanger systems that process very viscous products from 1,000 to over 35,000 cps and that require multiple product paths in order to handle high flow rates, from 100 to over 300 lbs per minute, without developing excessive inlet pressures (over 500 psi), are typically susceptible to product plugging or blockages. Blockages on any one or several of the multiple product paths in the heat exchanger system can result in improperly processed products which in turn can reduce final product quality and yield. In addition, the continuous processing of very viscous products which contain moisture or volatile compounds in many cases requires the product to be heated or cooled under pressure in a very controlled fashion. To reduce or avoid flashing of the moisture or other volatile components, a heat exchanger is needed that can handle various pressure and temperature ranges while not damaging the product matrix as it passes through the heat exchanger.

To solve this issue, heat exchanger systems were designed with multiple feed pumps feeding individual sets of heat exchangers. However, this type of design dramatically increases system design costs and complexity.

Moreover, existing continuous processes to manufacture meat, fish or vegetable analog based foods that have delicate or thin cuts (i.e. shredded or carved) require extensive cooling and careful handling to maintain product images prior to packaging. Additionally, these processes are difficult to control, have lower yields, use equipment that is difficult to clean, and have lower product flexibility because only a limited number of product textures and/or shapes can be made. Current attempts to solve these problems include one or more of the following: adapting formulas with more costly ingredients like wheat gluten, using batch processes with large cooling and hold areas, and separate cutting steps.

In some cases increasing the amounts of high quality ingredients like wheat gluten or more expensive meat cuts can improve product quality, but they also dramatically increase product costs. Specialized cooling equipment can be used but typically increases manufacturing costs, requires greater factory floor space, and can be difficult to clean.

A continuous process to manufacture meat or other protein based analogue products that have shredded, carved or other delicate shapes comprises several key steps: 1) meat preparation, 2) meat emulsion preparation, 3) a pump-through heat-setting step, 4) initial cooling and cutting, 5) conveying and secondary cooling, 6) final cutting and/or shaping, 7) chunk and gravy mixing, 8) packaging filling and sealing, 9) sterilization, and 10) labeling and final packaging. In the high shear heat setting process, the hot chunk exiting the emulsifier is transferred through a hold tube. The purpose of the hold tube is to provide sufficient back pressure and initial cooling of the chunk to avoid uncontrolled moisture flashing. If flashing is not controlled, the chunk product matrix can be damaged, resulting in poor product quality and lower yields. On exiting the hold tube, the large round pieces are cut into quarters or other manageable sizes so that they can be transferred to the primary and final chunk cooling step. The primary cooling step typically occurs in a blast-like cooler or freezer. Extensive cooling is needed to allow the chunk texture to firm prior to the final cutting and shaping step. A firmer chunk allows for a cleaner cut with reduced fines which improves yields and fmal product quality.

Products produced with this type of process are generally considered to be of higher quality both from appearance and final texture as compared to competing processes. However, the process requires a material handling step of conveying the product to and from a blast freezer or similar cooling device.

### SUMMARY

The present disclosure provides a concentric symmetrical branched heat exchanger system. The system includes an inlet manifold that divides the product flow evenly in the first section of the system and also includes an array of tubular concentric heat exchangers arranged in parallel and in series. Flow through each leg of the system can be divided further with secondary manifolds. Division of the product flow enables efficient heat exchange at higher and controllable product flow rates and at lower heat exchanger inlet pressures. Having lower inlet pressures reduces the heat exchanger construction cost and allows the attachment of cutting devices at the exchanger exits to create uniquely shaped pieces. Cutting or shaping devices can be installed at the end of the branched heat exchanger to provide cooling and cutting in one process step while eliminating the material handling step of conveying product to and from a blast freezer or similar cooling device. Placement of the cutting and shaping devices directly at the exit of the heat exchanger reduces fines, provides a closed system which is easier to clean and has a smaller factory floor footprint, and allows the heat setting process to be run at higher temperatures and pressures.

In a general embodiment, a method is provided. The method includes the steps of dividing a food product, which is travelling through a single conduit, into at least two product streams that each enter a different branch of a heat exchanger array with about the same flow rate into each branch relative to the other branches, and each of the branches of the array comprises a heat exchanger.

In an embodiment, the method further comprises subjecting the food product to a shaping or cutting device as the food product exits the branches of the heat exchanger array.

In an embodiment, the method further comprises heating an inlet manifold that divides the food product.

In an embodiment, wherein each branch of the array comprises a tubular concentric heat exchanger comprising an outer shell fixedly positioned in the array and further comprising a center tube connected to an assembly reversibly connected to and removable from the outer shell, and the food product is directed into an annulus formed between the outer shell and the center tube. The method can further comprise reconfiguring one of the heat exchangers by sliding the center tube and the assembly out of an end of the branch of the array, reconfiguring the center tube and the assembly, and re-inserting the center tube and the assembly into the end of the branch of the array. Reconfiguring the center tube and the assembly can comprise an operation selected from the group consisting of changing counter-current heat exchange flow to cross-current heat exchange flow, adding in-line instrumentation, removing in-line instrumentation, replacing the center tube with another center tube having a different diameter, and combinations thereof. The method can further comprise directing heat exchange media through the center tube and through the outer shell of each of the tubular concentric heat exchangers.

In an embodiment, the method further comprises forming the food product into a shape as the product exits the branches of the array, and at least one of the branches forms a different shape of the food product relative to the other branches.

In another embodiment, a system is provided. The system includes an inlet manifold that directs a food product from a single conduit having a diameter into at least two branches of a heat exchanger array, each of the branches of the array has a diameter that is about the same as the other branches and smaller than the diameter of the single conduit, and each of the branches of the array comprises a heat exchanger.

In an embodiment, each of the branches of the array comprises a tubular concentric heat exchanger, each of the tubular concentric heat exchangers comprises a core inlet assembly connected by a center tube to a core outlet assembly, and the center tube conveys heat exchange media.

In an embodiment, each of the branches of the array comprises a first heat exchanger arranged in series with a second heat exchanger such that the first and second heat exchangers of each branch form a continuous path for the food product, and the second heat exchanger has a larger cross-sectional area than the first heat exchanger.

In an embodiment, the system further comprises an emulsifier that forms the food product and is upstream of the single conduit. A positive displacement pump can be positioned between the emulsifier and the inlet manifold.

In an embodiment, the inlet manifold comprises a primary inlet manifold that divides the food product from the single conduit into at least two product streams, and the inlet manifold further comprises a secondary manifold that is positioned between the inlet manifold and the array and further divides the product flow into at least two product streams.

In an embodiment, the system further comprises shaping or cutting devices that are directly attached to the exit of the heat exchanger array and positioned at an opposite end of the array relative to the inlet manifold.

In another embodiment, a method is provided. The method includes the steps of directing a food product from a single conduit into at least two branches of a heat exchanger array; and controlling parameters of heat exchange in each of the branches individually.

In an embodiment, the method comprises individually controlling valves in the array, wherein each of the branches of the array comprises a first heat exchanger and a second heat exchanger arranged in series, and the valves are positioned at the inlet and the outlet of each of the branches.

In an embodiment, the method comprises automatically adjusting, in a heat exchanger in the array, a parameter selected from the group consisting of a flow rate of heat exchange media, a temperature of heat exchange media, and a combination thereof in response to product flow rate though the heat exchanger. The parameters in each of the branches can be automatically and individually controlled in response to measurements from in-line instrumentation in each of the branches. The measurements can be selected from the group consisting of pressures, temperatures, flow rates, and combinations thereof.

An advantage of the present disclosure is to heat or cool very viscous materials without the need of multiple product feed pumps.

Still another advantage of the present disclosure is to heat or cool very viscous materials while reducing heat exchanger blockages and improving final product quality and overall process performance.

Furthermore, an advantage of the present disclosure is to heat or cool very viscous materials with improved process control and increased expandability and flexibility.

Yet another advantage of the present disclosure is to heat or cool very viscous materials while optimizing the placement of a product forming, shaping and cutting apparatus at the heat exchanger exit.

Another advantage of the present disclosure is a heat exchanger design that can be easily cleaned and is more hygienic.

Still another advantage of the present disclosure is to heat or cool materials used for the manufacture of food-based products, such as meat/fish analogs or other food products that can be easily damaged when heated or cooled.

Yet another advantage of the present disclosure is to heat or cool products with high viscosity, for example polymers, pastes, sludge, gums, and the like.

Another advantage of the present disclosure is to heat or cool a material being processed that requires a textural change while still maintaining the underlying structure of the material as it exits the heat exchanger.

Still another advantage of the present disclosure is to provide expandability and greater process flexibility by providing a heat exchanger that is assembled in branched sections.

Another advantage of the present disclosure is to reduce the factory floor footprint of a heat exchanger by connecting sections with double elbows so that the sections can be stacked and expanded.

Still another advantage of the present disclosure is to improve process monitoring due to in-line placement of instrumentation, such as temperature probes, pressure transmitters or gauges, flow monitoring devices, and the like.

Another advantage of the present disclosure is to place valves between heat exchanger segments to divert product or isolate legs of the heat exchanger for clean-in-place or for shutting down portions of the heat exchanger array to reduce overall flow rates.

Still another advantage of the present disclosure is to provide precise temperature control on each heat exchanger branch.

Yet another advantage of the present disclosure is to obtain greater flexibility because the heating/cooling zones can be easily configured in series or parallel depending on product needs.

Still another advantage of the present disclosure is to provide a heat exchanger in which the tubes can be corrugated or in which static mixing devices can be added to augment heat transfer flow.

Yet another advantage of the present disclosure is to channel the product flow exiting the heat exchanger into cutting dies or grids to enable the manufacture of products with defined shapes and/or textures.

Still another advantage of the present disclosure is to place cutting dies and cutting equipment at the exit of the heat exchanger so that different shapes and cuts can be achieved, resulting in a wide range of products which cannot be produced with existing heat exchanger designs.

Yet another advantage of the present disclosure is to manufacture a variety of meat/fish analogue product types.

Still another advantage of the present disclosure is to lower the temperature of a hot chunk in a very controlled manner under pressure.

Furthermore, another advantage of the present disclosure is to eliminate the need for a freezer, a holding area, and independent cutting devices, thereby resulting in a completely continuous process while significantly reducing equipment footprint.

Yet another advantage of the present disclosure is to achieve increased flow cross sectional area so that backpressure can be reduced.

Still another advantage of the present disclosure is to improve heat transfer by allowing the addition of concentric inserts.

Furthermore, another advantage of the present disclosure is to improve heat transfer by using reduced product cross sectional areas while still allowing the processing of large product pieces, for example by using tube heat exchanger elements with a reduced diameter or using rectangular shaped heat exchanger elements with a reduced gap.

Yet another advantage of the present disclosure is to provide direct inline cutting and shaping of product as it exits the heat exchanger.

Still another advantage of the present disclosure is to achieve larger product formats in which larger product pieces can be formed, cut and/or shaped.

Furthermore, another advantage of the present disclosure is to obtain a more uniform product by transitioning the product cross sectional area in a gradual manner to reduce product fracturing and maintain product uniformity.

Yet another advantage of the present disclosure is to provide an expandable system by allowing stacking and angling of branches or heat exchanger elements.

Still another advantage of the present disclosure is to obtain greater process flexibility by allowing multi-zone cooling and by mixing different heat exchanger configurations.

Yet another advantage of the present disclosure is to achieve more uniform product flow through the heat exchanger.

Additional features and advantages are described herein, and will be apparent from, the following Detailed Description.

### BRIEF DESCRIPTION OF THE DRAWINGS

FIG. 1 is a perspective view of an embodiment of a symmetrical branched heat exchanger system provided by the present disclosure.

FIG. 2 is a side plan schematic view of a heat exchanger used in a leg of an embodiment of a branched heat exchanger system provided by the present disclosure.

FIG. 3 is a perspective end view of a heat exchanger used in a leg of an embodiment of a branched heat exchanger system provided by the present disclosure.

FIG. 4 is an end plan view of an exit plate used at the end of a leg of an embodiment of a branched heat exchanger system provided by the present disclosure.

FIG. 5 is a schematic diagram of an embodiment of a food processing system provided by the present disclosure.

FIGS. 6A-6C are schematic diagrams of embodiments of a symmetrical branched heat exchanger array provided by the present disclosure.

### DETAILED DESCRIPTION

As used in this disclosure and the appended claims, the singular forms “a,” “an” and “the” include plural referents unless the context clearly dictates otherwise. As used herein, “about” is understood to refer to numbers in a range of numerals that is from −10% to +10% relative to the referenced amount. For example, “about 100” refers to the range from 90 to 110. Moreover, all numerical ranges herein should be understood to include all integers, whole or fractions, within the range.

As used herein, “comprising,” “including” and “containing” are inclusive or open-ended terms that do not exclude additional, unrecited elements or method steps. However, the apparatuses and methods provided by the present disclosure may lack any element that is not specifically disclosed herein. Thus, any embodiment defined herein using the term “comprising” also is a disclosure of embodiments “consisting essentially of” and “consisting of” the recited elements.

The term “pet” means any animal which could benefit from or enjoy the food products provided by the present disclosure. The pet can be an avian, bovine, canine, equine, feline, hicrine, lupine, murine, ovine, or porcine animal. The pet can be any suitable animal, and the present disclosure is not limited to a specific pet animal. The term “companion animal” means a dog or a cat. The term “pet food” means any composition intended to be consumed by a pet.

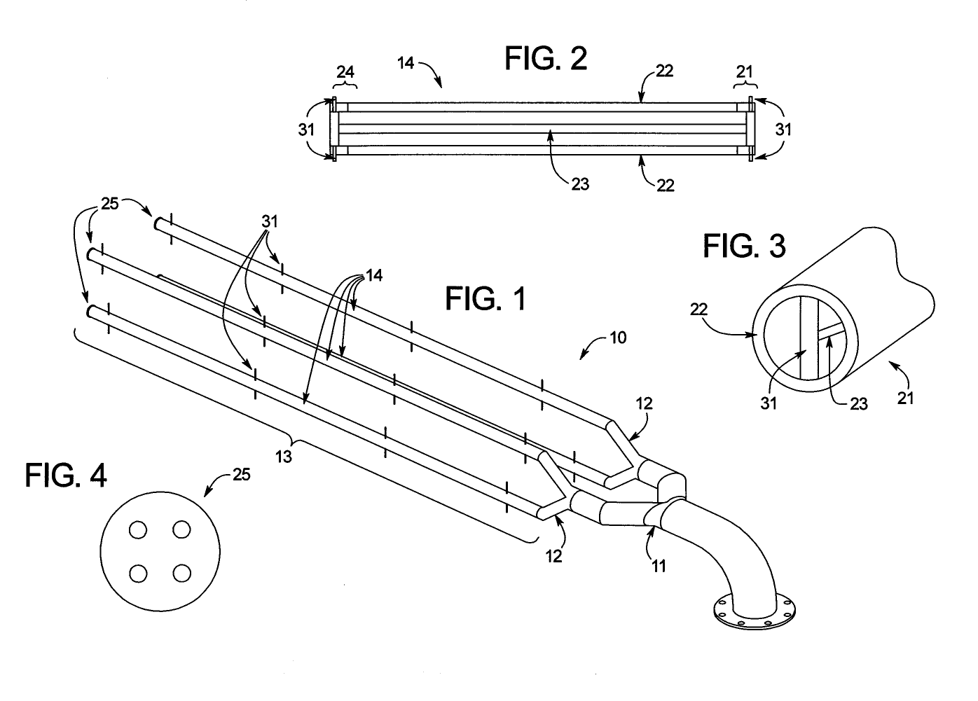

FIG. 1 generally illustrates an embodiment of a branched heat exchanger system 10 provided by the present disclosure. The branched heat exchanger system 10 comprises a primary inlet manifold 11 that allows a food product flowing from a single conduit to be split evenly, for example from one tube diameter to at least two smaller tube diameters that are about the same as each other. The food product can be a pet food, although compositions intended for consumption by humans are also included in the present disclosure. The food product can be very viscous. For example, the food product can have a viscosity of 1,000 cps or more; 2,000 cps or more; 10,000 cps or more; 100,000 cps or more; or even 200,000 cps or more. The product flow can be split into two or more product streams by the primary inlet manifold 11, and preferably the streams have about the same flow rate relative to each other.

The split product stream can then pass through a secondary inlet manifold 12 which further splits the product stream prior to entering a heat transfer section (heat exchanger array 13) in the branched heat exchanger system 10. The secondary inlet manifold 12 further divides the product streams evenly, for example from one tube diameter to at least two smaller tube diameters that are about the same as each other. Preferably the product streams have about the same flow rate relative to each other as they enter the heat exchanger array 13. Any number of secondary inlet manifolds 12 can be used, and the food product streams can be evenly divided any number of times.

By evenly splitting the product flow streams in this fashion, higher overall product flow rates can be achieved while reducing heat exchanger inlet pressures. Having lower inlet pressures reduces the overall cost of the branched heat exchanger system 10. In addition, the split product flows allow the application of more heat transfer areas to a given product flow.

After the product flow is split evenly one or more times, the food product enters two or more branches or legs of the heat exchanger array 13 (“branch” and “leg” are used synonymously herein). Each of the product streams enters a corresponding branch of the array 13. The heat exchanger array 13 can comprise heat exchangers 14 arranged within the branches. As shown in FIG. 1, one of the branches can be connected to another branch and the secondary inlet manifold 12 by a double shoulder such that these branches are vertically aligned, and other branches in the array 13 can be similarly configured.

Preferably, each branch of the heat exchanger array 13 has about the same length and has about the same flow cross section at a given distance along the length as the other branches. In an embodiment, each branch is identical in physical characteristics to the other branches in the array 13. Each branch can be configured with one or more heat exchanger sections to apply multi-zone cooling or heating to the food product. Cooling or heating of each branch of the heat exchanger array 13 can be controlled independently but preferably uniformly to allow even distribution of product flow through each branch of the heat exchanger array 13. Each heat exchanger element can be tubular, rectangular or another shape. Each of the branches of the heat exchanger array 13 can have heat exchanger elements with differently shaped flow cross sections within the branch. One or more sections of each branch can be pitched or angled to allow for volatile components of the product stream to exit the heat exchanger system 10 in a controlled fashion.

Each leg of the heat exchanger array 13 can comprise one or more of the heat exchangers 14, and if more than one of the heat exchangers 14 is used, they are placed in series such that the heat exchangers 14 form segments of the legs of the array 13. FIG. 1 shows each leg of the heat exchanger array 13 having three heat exchangers 14 in series, but the heat exchanger array 13 can have any number of heat exchangers 14 in each leg. The heat exchangers 14 in series in a leg of the heat exchanger array 13 form a continuous path for product to travel through the leg of the heat exchanger array 13. Valves and/or other instrumentation, such as temperature probes, pressure transmitters or gauges, flow monitoring devices, and the like, can be positioned between adjacent heat exchangers 14 in a leg of the array 13 and/or within one or more of the heat exchangers 14. In an embodiment, the branches of the array 13 can have different features such that portions of the food product can be processed differently as discussed in more detail hereafter.

As shown in FIG. 2, one or more of the heat exchangers 14 in a branch of the array 13 can be a concentric heat exchanger comprising a concentric insert. For example, one or more of the heat exchangers 14 in a branch of the array 13 can comprise a core inlet assembly 21, a core outlet assembly 24, and a center tube 23 that connects the core inlet assembly 21 to the core outlet assembly 24 and through which a heat transfer media for heating or cooling flows. Each branch of the array 13 comprises a shell 22 such that the center tube 23 can be inserted into the shell 22 to form an annulus between the center tube 23 and the shell 22. In an embodiment, the shell 22 can be fixedly positioned in the array 13. However, in some embodiments, the heat exchanger array 14 does not comprise any concentric heat exchangers.

In any heat exchangers 14 which are concentric heat exchangers, the heat transfer media for heating or cooling can flow within the shell 22 and through the center tube 23 while the food product flows through the annulus in the same direction (cross-current heat exchange flow) or the opposite direction (counter-current heat exchange flow). The outer portion of the annulus of the heat exchanger 14 is the shell 22 and the innermost portion of the annulus is the center tube 23. As product moves down the length of the heat exchanger 14, the product can be heated or cooled on both sides, specifically by the shell 22 on the outer product surface and by the center tube 23 on the inner product surface.

As the food product passes into the heat exchanger 14, the product flow is channeled around the core inlet assembly 21. The core inlet assembly 21 facing the product path has a streamlined design and can contain a leading edge to reduce product drag and prevent product from building up at the entrance to the heat exchanger 14. The core inlet assembly 21 channels product flow coming off the heat transfer element (the center tube 23) and allows the heat transfer media to exit from the heat exchanger 14 without contacting the product stream. For example, the core inlet assembly 21 can comprise one or more pipes 31 connected to the center tube 23 and extending from the interior of the heat exchanger 14 through the shell 22 to the exterior of the heat exchanger 14. In an embodiment, the one or more pipes 31 in the core inlet assembly 21 can be substantially perpendicular to the center tube 23, as shown in FIG. 3.

When the food product approaches the exit of the heat exchanger 14, the product is channeled past the core outlet assembly 24. As with the core inlet assembly 21, the core outlet assembly 24 is streamlined and may contain a leading edge in order to prevent product buildup or plugging at the exit of each heat exchanger 14. The core outlet assembly 24 channels product flow around the heat transfer element (the center tube 23) and allows the heat transfer media to enter the center tube 23 without contacting the product stream. For example, the core outlet assembly 24 can comprise one or more pipes 31 connected to the center tube 23 and extending from the exterior of the heat exchanger 14 through the shell 22 to the interior of the heat exchanger 14. In an embodiment, the one or more pipes 31 in the outlet assembly 24 can be substantially perpendicular to the center tube 23, as shown in FIG. 3. The food product exiting the heat exchanger 14 then enters any subsequent heat exchanger 14 in the leg of the heat exchanger array 13 of the branched heat exchanger system 10.

Each core inlet assembly 21 is connected to the corresponding core outlet assembly 24 by the center tube 23 through which the heat transfer media flows. The heat exchanger 14 can thus be formed by inserting the core inlet assembly 21, the core outlet assembly 24 and the center tube 23 into the shell 22 in the desired configuration. By connecting the core inlet assembly 21 with the corresponding core outlet assembly 24, the center tube 23 forms the core of the heat exchanger 14. For example, the center tube 23 can be connected to the core outlet assembly 24 and inserted into the shell 22, and the open end of the center tube 23 can be connected to the core inlet assembly 21, forming a concentric heat exchanger 14. Each of the heat exchangers 14 are connected to an exit of the secondary inlet manifolds 12 to assemble the system 10 and obtain the desired configuration of the system 10. To change the configuration of the system 10, the core outlet assembly 24 and the center tube 23 can be disconnected from the core inlet assembly 21. The core outlet assembly 24 and the center tube 23 can then be removed out of the end of the corresponding branch of the array 13. Then a new configuration of the center tube 23 and the core outlet assembly 24 can be connected and inserted into the shell 22 and connected to the open end of a matching configuration of the core inlet assembly 21, forming a heat exchanger 14. Each of the newly configured heat exchangers 14 can be connected to the exit of the secondary inlet manifolds 12 to form the heat exchanger array 13.

To facilitate assembly of the heat exchanger 14 within the shell 22 of the heat exchanger 14, one end of the center tube 23 can be threaded, welded or have a suitable compression fitting to the back side of the core inlet assembly 21. The other end of the center tube 23 can then be threaded, welded or have a suitable compression fitting to the core outlet assembly 24. Preferably at least one end of the concentric heat exchanger 14 (core inlet assembly 21, center tube 23 and core outlet assembly 24) is detachable to ease assembly and disassembly of the heat exchanger 14. A suitable gasket can be added to the threaded portion of the connection to prevent the heat transfer media from entering the product stream.

As shown in FIGS. 1 and 4, the branched heat exchanger system 10 can comprise exit plates 25 at the end of the heat exchanger array 13 opposite to the primary inlet manifold 11. For example, the last heat exchanger 14 of each leg of the array 13 of the branched heat exchanger system 10 can have one of the exit plates 25 attached thereto. The food product can reach the exit plate 25 after travelling through all of the heat exchangers 14 in series in the leg of the array 13 into which the food product was directed by the primary inlet manifold 11 and/or the secondary inlet manifold 12.

The exit plates 25 can shape the product as the product is directed out of the array 13. For example, each of the exit plates 25 can have one or more orifices that impart a desired shape on the product travelling through the exit plate 25. The exit plates 25 are preferably directly attached to the heat exchanger array 13 so that the product exiting the array 13 and being shaped by the exit plate 25 occurs substantially simultaneously as one step.

The above description is based on the heat exchanger 14 being configured for counter-current flow. However, the heat exchanger 14 can easily be configured for cross-current flow such that the food product enters the heat exchanger 14 proximate to the core outlet assembly 24 and exits the heat exchanger 14 proximate to the core inlet assembly 21. In this regard, the heat exchanger array 13 can comprise the heat exchangers 14 in parallel and/or series configurations to provide more flexibility, particularly when processing products or materials that may require unique heating or cooling profiles.

If a second heat exchanger 14 is connected to a first heat exchanger 14 in a leg of the heat transfer array 13, the shapes of the core inlet assembly 21 and the adjacent core outlet assembly 24 can be different relative to each other to ensure that the assemblies 21 and 24 align correctly. For example, the core inlet assembly 21 and the adjacent core outlet assembly 24 can have complementary surfaces relative to each other. In an embodiment, the front and the back of the first core inlet assembly 21 can have a leading edge. The back side of the first core outlet assembly 24 can be flat so that the back side of the first core outlet assembly 24 can be aligned with a flat face of the second core inlet assembly 21 within the leading edge. To ensure proper alignment, the flat surfaces can be machined with a key or set of pins. The core inlet assembly 21 and/or the core outlet assembly 24 can connect to the shell 22 of the array 13 using a bolted flange, an “I” line type fitting, or another suitable fitting to provide easy assembly or disassembly. For example, the core inlet assembly 21 and/or the core outlet assembly 24 can reversibly connect to the shell 22 of the array 13. To ensure that the connections between the heat exchangers 14 are secure and to prevent product leaks, a gasket can be used between the connecting metal surfaces, enabling a sanitary design. The design of the heat exchangers 14 also enables a clean-in-place without disassembly of the heat exchanger 14.

In an embodiment, each of the outlet assemblies is reversibly removable relative to the adjacent outlet assembly of another heat exchanger 14 in the same leg of the heat exchanger array 13. For example, each of the outlet assemblies can be reversibly connected to and disconnected from the adjacent outlet assembly of another heat exchanger 14 in the same leg of the heat exchanger array 13. A selected heat exchanger 14 in the array 13 can be reconfigured to comprise desired in-line instrumentation and/or another desired characteristic. For example, the selected heat exchanger can be reconfigured to comprise a differently sized central tube 23 which can provide a different amount of heat exchange media and/or a different annulus size; a different type of center tube 23 such as a corrugated tube; a static mixing device positioned in the flow of the heat transfer media and/or in the food product stream depending, for example, on viscosities, the amount of fiber or particulates present, and the like; and/or different in-line instrumentation such as temperature probes, pressure transmitters or gauges, flow monitoring devices, and the like. Alternatively or additionally, static mixing devices and in-line instrumentation can be positioned between the heat exchangers 14 in a leg of the array 13. The selected heat exchanger 14 can be replaced without replacing the upstream heat exchangers 14 in the same leg of the array 13. As a result, the in-line configuration of the system 10 can be easily and flexibly changed as desired.

The present disclosure also provides a continuous process to manufacture meat or other protein based analogue products that have shredded, carved or other delicate shapes. The process can comprise a high-shear heat-setting step in an emulsifier, and then the hot chunk exiting the emulsifier can be transferred through the branched heat exchanger system 10 for cooling. The process can enable the continuous manufacture of pet food, meat or other protein based analogue products that have unique textures or shape.

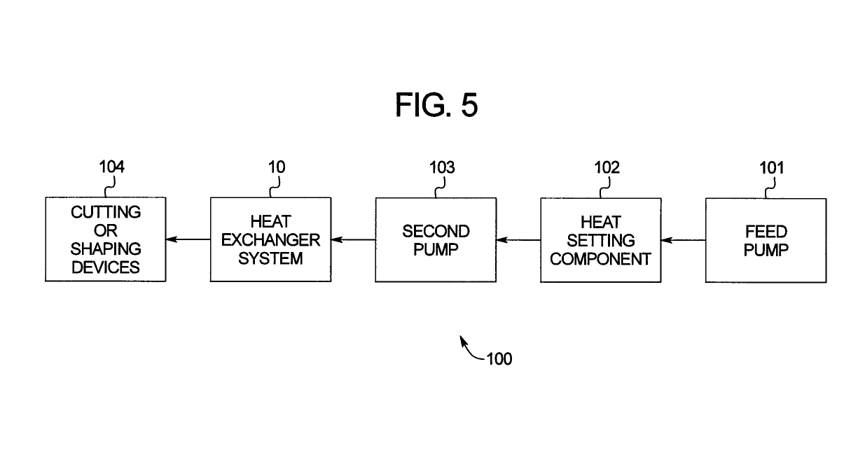

The continuous process can utilize a food processing system 100 shown in FIG. 5. The food processing system 100 can comprise a feed pump 101; a pump-through heat setting component 102 (a high shear emulsifier, microwave, ohmic and/or radio frequency heating component); optionally a second pump 103 that can be a high pressure pump, depending on product volumes, formulations, viscosity, and the like; the branched heat exchanger system 10; and cutting or shaping devices 104, such as devices comprising the exit plates 25, at the end of the heat exchanger array 13 opposite to the primary inlet manifold 11. The process handles food-type products, so preferably all equipment is designed to be clean-in-place and constructed of suitable food grade materials.

The process can provide cooling or heating and then finally cutting in one process step while eliminating the material handling step of conveying product to and from a blast freezer or similar cooling device. In the process, placement of cutting or shaping devices directly at the exits of the heat exchanger array 13 reduces fines and provides a closed system which is easier to clean and has a smaller factory floor footprint. This design enables the heat setting process to be performed at higher temperatures and pressures. By processing at higher temperatures and pressures, greater product texturization can be achieved. In turn, greater texturization enables the manufacture of a wider range of final products of high quality as compared to existing processes that use double tube, large single concentric tubular, and straight pass plate heat exchangers.

The process utilizes the branched heat exchanger system 10 after the heat setting step. For example, if the heat setting step uses a high shear emulsifier downstream from the feed pump 101, the product can be heated and emulsified and then pumped through the branched heat exchanger system 10. Preferably, the branched heat exchanger system 10 comprises only one feed pump 101. The branched heat exchanger system 10 can comprise the second pump 103, and the second pump 103 is positioned between the heat setting component 102 (e.g. an emulsifier) and the branched heat exchanger system 10. The second pump 103 can boost the product pressure so that the product can be transferred more easily and consistently through the branched heat exchanger system 10 while controlling pressure at the heating step in the heat setting component 102. The branched heat exchanger system 10 can lower the temperature of the hot chunk in a very controlled manner under pressure. The forming and/or cutting devices 104, such as devices comprising the exit plates 25, are attached to the branched heat exchanger system 10 at the exits of the heat exchanger array 13.

As detailed above, the branched heat exchanger system 10 used in this process can have a symmetrically branched tubular design and can have concentric inserts, such as the center tube 23, the inlet core assembly 21 and the outlet core assembly 24. The branched heat exchanger system 10 is symmetrically branched by splitting the product flow evenly, for example from one larger tube diameter to at least two smaller but equal tube diameters. The branching or splitting can be done multiple times if needed as long as the product flow is divided evenly each time. By having the flow divided symmetrically, the product flow can be evenly distributed between each branch or leg of the heat exchanger array 13. Concentric inserts with cooling capability, such as the center tube 23, the core outlet assembly 24 and the core inlet assembly 21, can be used to form an annulus in the heat exchanger 14 to improve heat transfer as compared to conventional heat exchangers. Due to the high viscosity and fibrous nature of heat-set meat emulsions, these concentric inserts can be designed to ensure consistent flow along the length of the heat exchanger array 13 and between the heat exchangers 14 that form segments of the array 13.

By designing the heat exchanger system 10 with symmetrically branched segments, higher volumes can be achieved while reducing heat exchanger inlet pressures. To ensure proper flow of the chunk product prior to the cooling sections of the branched heat exchanger system 10, the branched segments (the primary inlet manifold 11 and the secondary inlet manifold 12) can be heated. This heating can reduce product build-up on the side walls of the branched segments of the heat exchanger system 10 prior to entering the heat exchanger array 13. Also, to ensure proper flow and minimize product build-up on the side walls of the branched heat exchanger system 10, the surfaces that will contact the product can be highly polished and can be made of suitable food grade material such as stainless steel.

The flow between the branched legs of the branched heat exchanger system 10 can be automatically controlled by changing the flow and/or the temperature of the heat transfer media, for example by a processor. In an embodiment, the processor can be communicatively connected to and control pumps, valves and/or temperature controlling devices connected to the pipes 31 and/or the central tubes 23 which convey the heat exchange media. Cooling in each heat exchanger 14 of the array 13 can be configured in parallel or series depending on the cooling profile needed. To provide increased flexibility, the connections for the heat transfer media, such as the connections between the center tube 23, the inlet core assembly 21, the outlet core assembly 24, and the outer shell 22, can be the quick-disconnect type so that the cooling configuration can be easily modified. Depending on product volumes and allowable pressures, the heat exchangers 14 of the array 13 can be connected and/or stacked to enable larger amounts of heat exchanger area in a smaller factory footprint. In-line flow meters, temperature probes, pressure transmitters and/or or other types of process instrumentation can be fitted in-line to provide an understanding of process conditions. These process conditions can then be used to maintain control of each branch of the heat exchanger array 13. For example, if a flow meter indicates a reduction in product flow in one of the branches of the heat exchanger array 13, then cooling can be reduced to that branch to enable more product flow.

After the food product passes through the heat exchanger array 13, the product can be re-sized to meet various final product images. The forming and/or cutting devices 104, such as grids of static or vibrating knives, can be attached on the exits of the heat exchanger array 13. These knife grids can have vertical, horizontal and/or diagonal knives, depending on the shape of the product to be manufactured. If more defined shapes are required, cutting dies with more complex designs can be fitted to the exits of the heat exchanger array 13. Sets of cutting dies with different shapes can be fitted at each of the exits of the heat exchanger array 13 to enable the production of differently shaped products at the same time. For example, a first type of cutting die can be used on a subset of the exits, a second type of cutting die can be used on another subset of the exits, and the first and second types of cutting die can form shapes having at least one different characteristic relative to each other. In conjunction with the knife grids or cutting dies, a rotating or similar type cross-cutting device can be attached. This cross-cutting device allows the exiting material to be cut to the required thickness or length. The speed of the cross-cutter can be automatically controlled depending on product flow rates, for example by a processor.

The second pump 103, which is used between the heat setting component 102 (e.g. an emulsifier) and the heat exchanger system 10, preferably is a positive displacement pump able to transfer chunk material at suitable pressures while allowing for consistent flow between each branch of the heat exchanger array 13. Flow in each of the branches can be controlled by having consistent flow with low pulsation and, if necessary, changing the amount of cooling in each of the branches of the heat exchanger array 13. The second pump 103 can be a piston, rotary lobe or gear pump. In an embodiment, a rotary lobe or gear pump is used because these types of pumps can be placed directly in-line. The second pump 103 is selected to handle the required inlet/outlet pressures.

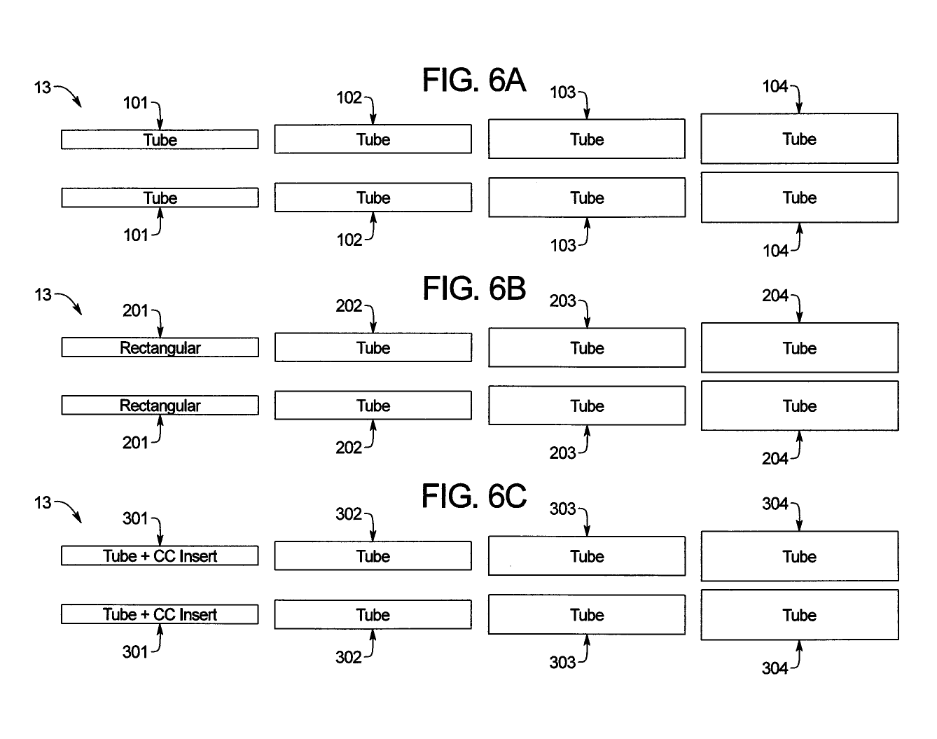

As shown in FIGS. 6A-6C, each of the branches of the heat arranger array 13 can be arranged with an increasing cross sectional flow area from the inlet to the exit of each branch. Preferably each of the branches has the same rate by which the cross sectional flow area increases; for example, at a given distance along the length of a branch, the branch has the same cross sectional flow area relative to the same distance in the other branches. In an embodiment, the increasing cross sectional flow area can be achieved by configuring the heat arranger array 13 such that each of the heat exchangers 14 has a larger cross sectional area relative to the previous heat exchanger 14. For example, each of the heat exchangers 14 can have a larger diameter relative to the previous heat exchanger 14. The transition between heat exchangers 14 can be configured so the cross sectional area and/or the shape of the product flow are gradually changed to minimize mechanical stress on the food product.

For example, FIG. 6A shows an embodiment of the heat arranger array 13, and each branch of the array 13 comprises a tubular first heat exchanger section 101 connected to a tubular second heat exchanger section 102 which has a larger diameter than the tubular first heat exchanger section 101. In each branch, the tubular second heat exchanger section 102 is connected to a tubular third heat exchanger section 103 which has a larger diameter than the tubular second heat exchanger section 102, and the tubular third heat exchanger section 103 is connected to a tubular fourth heat exchanger section 104 which has a larger diameter than the tubular third heat exchanger section 103. The heat exchanger array 13 according to the present disclosure is not required to have a concentric insert; in the embodiment depicted in FIG. 6A, the heat exchanger sections 101-104 do not have concentric inserts.

As another example, FIG. 6B shows an embodiment of the heat arranger array 13, and each branch of the array 13 comprises a rectangular first heat exchanger section 201 connected to a tubular second heat exchanger section 202 which has a larger cross sectional area than the rectangular first heat exchanger section 201. In each branch, the tubular second heat exchanger section 202 is connected to a tubular third heat exchanger section 203 which has a larger diameter than the tubular second heat exchanger section 202, and the tubular third heat exchanger section 203 is connected to a tubular fourth heat exchanger section 204 which has a larger diameter than the second tubular heat exchanger section 203. The heat exchanger array 13 according to the present disclosure is not required to have a concentric insert; in the embodiment depicted in FIG. 6B, the heat exchanger sections 201-204 do not have concentric inserts.

As yet another example, FIG. 6C shows an embodiment of the heat arranger array 13, and each branch of the array 13 comprises a tubular first heat exchanger section 301 comprising a concentric insert and connected to a tubular second heat exchanger section 302 which has a larger diameter than the tubular first heat exchanger section 301. In each branch, the tubular second heat exchanger section 302 is connected to a tubular third heat exchanger section 303 which has a larger diameter than the tubular second heat exchanger section 302, and the tubular third heat exchanger section 303 is connected to a tubular fourth heat exchanger section 304 which has a larger diameter than the tubular third heat exchanger section 303.

The embodiments shown in FIGS. 6A-6C are non-limiting examples and do not limit the configuration of the heat exchanger array 13 in any way. Two branches are shown for each of the depicted embodiments, but any number of symmetrical branches can be used in the heat exchanger array 13, preferably with the length and the cross sectional area at a given distance along the length being the same between the branches. Moreover, each of these embodiments may be combined with another embodiment depicted in FIGS. 6A-6C and/or with any other embodiment disclosed herein.

The food product processed using the devices and methods disclosed herein can comprise one or more of a flavor, a color, an emulsified or particulate meat, a protein, an emulsified or particulate fruit, an emulsified or particulate vegetable, an antioxidant, a vitamin, a mineral, a fiber or a prebiotic.

Non-limiting examples of suitable flavors include yeast, tallow, rendered animal meals (e.g., poultry, beef, lamb, pork), flavor extracts or blends (e.g., grilled beef), spices, and the like. Suitable spices include parsley, oregano, sage, rosemary, basil, thyme, chives and the like. Non-limiting examples of suitable colors include FD&C colors, such as blue no. 1, blue no. 2, green no. 3, red no. 3, red no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan.

Non-limiting examples of suitable meats for use as emulsified or particulate meat include poultry, beef, pork, lamb and fish, especially those types of meats suitable for pets. Any of the meats and meat by-products may be used, including meats such as whole-carcass beef and mutton; lean pork trim; beef shanks; veal; beef and pork cheek meat; and meat by-products such as lips, tripe, hearts, tongues, mechanically deboned beef, chicken or fish, beef and pork liver, lungs, kidneys, and the like. In an embodiment, the meat is a combination of different types of meats. The food product is not limited to a specific meat or combination of meats, and any meat known to the skilled artisan for making a food composition can be used.

Additionally or alternatively, vegetable protein and/or cereal protein can be used, such as canola protein, pea protein, corn protein (e.g., ground corn or corn gluten), wheat protein (e.g., ground wheat or wheat gluten), soy protein (e.g., soybean meal, soy concentrate, or soy isolate), rice protein (e.g., ground rice or rice gluten) and the like. If flour is used, it will also provide some protein. Therefore, a material can be used that is both a vegetable protein and a flour.

Non-limiting examples of suitable vegetables for use as emulsified or particulate vegetables include potatoes, squash, zucchini, spinach, radishes, asparagus, tomatoes, cabbage, peas, carrots, spinach, corn, green beans, lima beans, broccoli, brussel sprouts, cauliflower, celery, cucumbers, turnips, yams, and combinations thereof. Non-limiting examples of suitable fruits for use as emulsified or particulate fruits include apple, orange, pear, peach, strawberry, banana, cherry, pineapple, pumpkin, kiwi, grape, blueberry, raspberry, mango, guava, cranberry, blackberry or combinations thereof. The food product is not limited to a specific emulsified or particulate fruit or vegetable or combination thereof, and any fruit or vegetable known to the skilled artisan for making a food composition can be used.

Non-limiting examples of suitable vitamins include vitamin A, any of the B vitamins, vitamin C, vitamin D, vitamin E, and vitamin K, including various salts, esters, or other derivatives of the foregoing. Non-limiting examples of suitable minerals include calcium, phosphorous, potassium, sodium, iron, chloride, boron, copper, zinc, magnesium, manganese, iodine, selenium, and the like. Non-limiting examples of suitable antioxidants include BHA/BHT, vitamin E (tocopherols), and the like.

Non-limiting examples of suitable fibers include digestible or indigestible, soluble or insoluble, fermentable or non-fermentable fibers. Preferred fibers are from plant sources such as marine plants but microbial sources of fiber may also be used. A variety of soluble or insoluble fibers may be utilized.

Non-limiting examples of suitable prebiotics include fructo-oligosaccharides, gluco-oligosaccharides, galacto-oligosaccharides, isomalto-oligosaccharides, xylo-oligosaccharides, soybean oligosaccharides, lactosucrose, lactulose, and isomaltulose. In an embodiment, the prebiotic is chicory root, chicory root extract, inulin, or combinations thereof. Generally, prebiotics are administered in amounts sufficient to positively stimulate the healthy microflora in the gut and cause these “good” bacteria to reproduce. Typical amounts are from about one to about 10 grams per serving or from about 5% to about 40% of the recommended daily dietary fiber for an animal.

Selection of the amounts of each ingredient of the food product is known to skilled artisans. Specific amounts for each additional ingredient will depend on a variety of factors such as the ingredient included in the coating composition; the species of animal; the animal's age, body weight, general health, sex, and diet; the animal's consumption rate; the purpose for which the food product is administered to the animal; and the like. Therefore, the identity and amounts of the ingredients may vary widely and may deviate from the preferred embodiments described herein.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method comprising the steps of dividing a food product, which is travelling through a single conduit, into at least two product streams that each enter a different branch of a heat exchanger array with about the same flow rate into each branch relative to the other branches, and each branch comprises a heat exchanger.

2. The method of claim 1, further comprising subjecting the food product to a shaping or cutting device as the food product exits the branches of the array.

3. The method of claim 1, further comprising heating an inlet manifold that divides the food product.

4. The method of claim 1, wherein each branch of the array comprises a tubular concentric heat exchanger comprising an outer shell fixedly positioned in the array and further comprising a center tube connected to an assembly reversibly connected to and removable from the outer shell, and the food product is directed into an annulus formed between the outer shell and the center tube.

5. The method of claim 4, further comprising reconfiguring one of the heat exchangers by sliding the center tube and the assembly out of an end of the branch of the array, reconfiguring the center tube and the assembly, and re-inserting the center tube and the assembly into the end of the branch of the array.

6. The method of claim 5, wherein reconfiguring the center tube and the assembly comprises an operation selected from the group consisting of changing counter-current heat exchange flow to cross-current heat exchange flow, adding in-line instrumentation, removing in-line instrumentation, replacing the center tube with another center tube having a different diameter, and combinations thereof.

7. The method of claim 4, further comprising directing heat exchange media through the center tube and through the outer shell of each of the tubular concentric heat exchangers.

8. The method of claim 1, further comprising forming the food product into a shape as the product exits the branches of the array, and at least one of the branches forms a different shape of the food product relative to the other branches.

9. A system comprising an inlet manifold that directs a food product from a single conduit having a diameter into at least two branches of a heat exchanger array, each of the branches of the array has a diameter that is about the same as the other branches and smaller than the diameter of the single conduit, and each of the branches of the array comprises a heat exchanger.

10. The system of claim 9, wherein each of the branches of the array comprises a tubular concentric heat exchanger, each of the tubular concentric heat exchangers comprises a core inlet assembly connected by a center tube to a core outlet assembly, and the center tube conveys heat exchange media.

11. The system of claim 9, wherein each of the branches of the array comprises a first heat exchanger arranged in series with a second heat exchanger such that the first and second heat exchangers of each branch form a continuous path for the food product, and the second heat exchanger has a larger cross-sectional area than the first heat exchanger.

12. The system of claim 9, further comprising an emulsifier that forms the food product and is upstream of the single conduit.

13. The system of claim 12, further comprising a positive displacement pump positioned between the emulsifier and the inlet manifold.

14. The system of claim 9, wherein the inlet manifold comprises a primary inlet manifold that divides the food product from the single conduit into at least two product streams, and the inlet manifold further comprises a secondary manifold that is positioned between the inlet manifold and the array and further divides the product flow into at least two product streams.

15. The system of claim 9, further comprising shaping or cutting devices that are directly attached to the exit of the heat exchanger array and positioned at an opposite end of the array relative to the inlet manifold.

16. A method comprising the steps of directing a food product from a single conduit into at least two branches of a heat exchanger array; and controlling parameters of heat exchange in each of the branches individually.

17. The method of claim 16, comprising individually controlling valves in the array, wherein each of the branches of the array comprises a first heat exchanger and a second heat exchanger arranged in series, and the valves are positioned at the inlet and the outlet of each of the branches.

18. The method of claim 16, comprising automatically adjusting, in a heat exchanger in the array, a parameter selected from the group consisting of a flow rate of heat exchange media, a temperature of heat exchange media, and a combination thereof in response to product flow rate though the heat exchanger.

19. The method of claim 16, wherein the parameters in each of the branches are automatically and individually controlled in response to measurements from in-line instrumentation in each of the branches.

20. The method of claim 19, wherein the measurements are selected from the group consisting of pressures, temperatures, flow rates, and combinations thereof.
